(19) United States
(12) Patent Application Publication
(10) Pub. No.: US 2026/0109158 A1
(43) Pub. Date: Apr. 23, 2026

(54) INKJET RECORDING APPARATUS

(71) Applicant: CANON KABUSHIKI KAISHA, Tokyo (JP)

(72) Inventors: YUSUKE YAMAGUCHI, Chiba (JP); YASUHARU CHIYODA, Chiba (JP); TOSHINORI NAKAYAMA, Chiba (JP); DAIGO MATSUURA, Tokyo (JP); SHUTARO SAITO, Tokyo (JP); KOHEI AOKI, Chiba (JP); YUTARO OKADA, Chiba (JP)

(21) Appl. No.: 19/353,357

(22) Filed: Oct. 8, 2025

(30) Foreign Application Priority Data
Oct. 21, 2024 (JP) 2024-184916

(51) Int. Cl. B41J 11/00; G01K 1/02; G05D 23/19; H05B 1/02; H05B 3/00

(52) U.S. Cl. CPC B41J 11/00242; G01K 1/026; G05D 23/1931; H05B 1/0241; H05B 3/0066; H05B 2203/005

(57) ABSTRACT

An inkjet recording apparatus includes an image forming unit, a first belt, a second belt, a plurality of heating elements disposed on an inner peripheral side of the first belt along a sheet conveyance direction, and configured to heat the first belt, a power supply circuit, a temperature detection unit, and a control unit configured to individually control power to be supplied to the plurality of heating elements to cause the temperature of the first belt detected by the temperature detection unit to be adjusted to a predetermined target temperature, wherein, in a case where the power is supplied to the plurality of heating elements, the control unit controls a number of heating elements to which the power is to be supplied, to cause a duty of one heating element to exceed a first duty and to be less than a second duty greater than the first duty.

### BACKGROUND

### Field of the Technology

The present disclosure relates to one or more embodiments of an inkjet recording apparatus forming an image on a sheet by using ink.

### Description of the Related Art

In an inkjet recording apparatus, to raise a temperature of a belt to a target temperature as fast as possible, a belt having a low heat capacity is directly heated by a plurality of halogen heaters. Temperatures of the heaters are appropriately adjusted based on a detection result of a temperature sensor that detects a belt temperature. As in an apparatus described in Japanese Patent Laid-Open No. 2018-77265, conventionally, a heater temperature adjustment is performed by turning on and off a switching element of a power supply circuit supplying a voltage for operating the heater at high speed based on a pulse width modulation (PWM) signal (PWM control). The heater temperature is varied in accordance with a duty ratio of the PWM signal.

### SUMMARY

In an inkjet recording apparatus forming an image on a sheet by using ink, heat and pressure may be applied to the sheet by using paired belts abutting on each other, to fix the ink to the sheet. By using the paired belts, it is possible to ensure a nip length of a fixing nip portion that holds and conveys the sheet and fixes the ink to the sheet. This improves fixation of the ink to the sheet.

According to one or more aspects of the present disclosure, an inkjet recording apparatus may include an image forming unit configured or operating to form an image on a sheet by ejecting ink, a first belt having an endless configuration, a second belt having an endless configuration and configured or operating to be in contact with the first belt to form a nip portion, the nip portion holding, conveying, and heating the sheet on which the image has been formed by the image forming unit, a plurality of heating elements disposed on an inner peripheral side of the first belt along a sheet conveyance direction, and configured to heat the first belt, a power supply configured or operating to supply power to the plurality of heating elements, a temperature detection unit configured or operating to detect a temperature of the first belt, and a control unit configured or operating to individually control power to be supplied to the plurality of heating elements to cause the temperature of the first belt detected by the temperature detection unit to be adjusted to a predetermined target temperature, wherein, in a case where the power is supplied to the plurality of heating elements, the control unit further operates to control a number of heating elements to which the power is to be supplied, and to cause a duty of one heating element to exceed a first duty and to be less than a second duty greater than the first duty.

According to other aspects of the present disclosure, one or more additional inkjet recording apparatuses, one or more methods, and one or more storage mediums are discussed herein. Features of the present disclosure will become apparent from the following description of embodiments with reference to the attached drawings. The following description of embodiments is described by way of example.

### BRIEF DESCRIPTION OF THE DRAWINGS

FIG. 1 is an outline diagram illustrating at least one embodiment of an inkjet recording apparatus according to one or more aspects of the present disclosure.

FIG. 2 is an outline diagram illustrating at least one embodiment of a fixing module according to one or more aspects of the present disclosure.

FIG. 3 is a schematic diagram illustrating at least one embodiment of a heating unit according to one or more aspects of the present disclosure.

FIG. 4A is a diagram illustrating at least one embodiment of a heater temperature sensor according to one or more aspects of the present disclosure, FIG. 4B is a diagram illustrating at least one viewing angle of the heater temperature sensor according to one or more aspects of the present disclosure, and FIG. 4C is a graph illustrating a relationship between a temperature measurement accuracy and the viewing angle according to one or more aspects of the present disclosure.

FIG. 5A is a diagram illustrating a heating intensity of at least one embodiment of a heater at positions in a belt width direction according to one or more aspects of the present disclosure, and FIG. 5B is a graph illustrating a change over time of a belt temperature according to one or more aspects of the present disclosure.

FIG. 6A is a block diagram illustrating at least one embodiment of a temperature control system of a heater according to one or more aspects of the present disclosure, and FIG. 6B is a block diagram illustrating at least one embodiment of a power supply or power supply circuit for supplying power to a lower heater according to one or more aspects of the present disclosure.

FIG. 7 is a flowchart illustrating at least one embodiment example of a heater control processing according to one or more aspects of the present disclosure.

FIG. 8 is a flowchart illustrating at least one embodiment example of a heater control processing according to one or more aspects of the present disclosure.

FIG. 9 is a set of three graphs illustrating a change over time of a belt temperature and a duty ratio of a pulse width modulation (PWM) signal output to each heater according to one or more aspects of the present disclosure.

FIG. 10 is a set of three graphs illustrating a change over time of a belt temperature and a duty ratio of a PWM signal output to each heater according to one or more aspects of the present disclosure.

FIG. 11 is a flowchart illustrating at least one additional embodiment example of a heater control processing according to one or more aspects of the present disclosure.

### DESCRIPTION OF THE EMBODIMENTS

### Configuration(s) of One or More Embodiments

### Embodiment(s) of an Inkjet Recording Apparatus

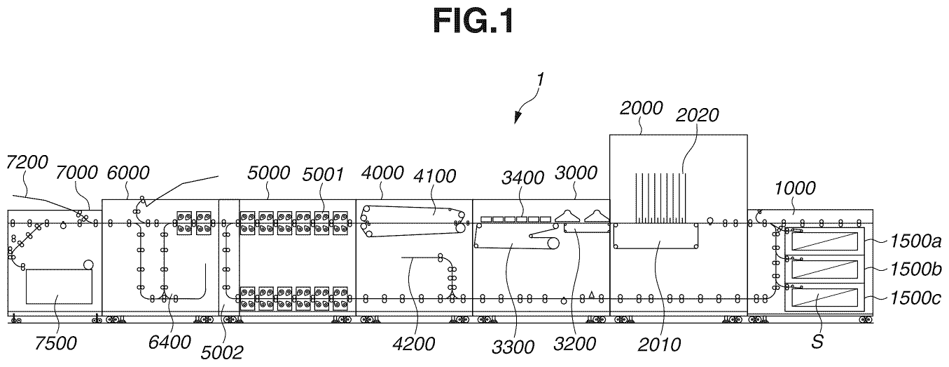

One or more embodiments of the present disclosure are described in detail below with reference to drawings. FIG. 1 is an outline diagram illustrating an inkjet recording apparatus according to one or more embodiments. An inkjet recording apparatus 1 illustrated in FIG. 1 is a so-called sheet-fed inkjet recording apparatus that forms an ink image on a sheet S by using two types of liquid, which are a reaction liquid and ink. The sheet S is a recording medium that may receive the ink, for example, paper such as plain paper and cardboard, a plastic film such as an overhead projector sheet, a recording medium having a special shape such as an envelope and index paper, and cloth.

As illustrated in FIG. 1, the inkjet recording apparatus 1 includes a sheet feeding module 1000, a print module 2000, a drying module 3000, a fixing module 4000, a cooling module 5000, a reversing module 6000, and a stacking module 7000. The sheet S supplied from the sheet feeding module 1000 is subjected to various kinds of processing while being conveyed in each of the modules along a conveyance path, and is finally discharged to the stacking module 7000.

Each of the sheet feeding module 1000, the print module 2000, the drying module 3000, the fixing module 4000, the cooling module 5000, the reversing module 6000, and the stacking module 7000 may have a separate housing, and these housings may be coupled to configure the inkjet recording apparatus 1. Alternatively, the sheet feeding module 1000, the print module 2000, the drying module 3000, the fixing module 4000, the cooling module 5000, the reversing module 6000, and the stacking module 7000 may be disposed in a single housing.

The sheet feeding module 1000 includes storages 1500a, 1500b, and 1500c each storing the sheet S. The storages 1500a to 1500c are drawable to an apparatus front surface side so that the sheet S are stored in the storages 1500a to 1500c. The sheet S is fed one by one by a separation belt and a conveyance roller in each of the storages 1500a to 1500c, and is conveyed to the print module 2000. The number of storages 1500a to 1500c is not limited to three, and may be one, two, or four or more.

The print module 2000 serving as an image forming unit includes a pre-image-formation registration correction unit (not illustrated), a print belt unit 2010, and a recording unit 2020. The sheet S conveyed from the sheet feeding module 1000 is corrected in inclination and position by the pre-image-formation registration correction unit, and is then conveyed to the print belt unit 2010. The recording unit 2020 is disposed at a position facing the print belt unit 2010 with respect to the conveyance path. The recording unit 2020 forms an image by ejecting the ink onto the conveyed sheet S from above by a plurality of recording heads. The plurality of recording heads for ejecting the ink is arranged along a conveyance direction of the sheet S. In the embodiments, the recording unit 2020 includes five line-type recording heads corresponding to four colors of yellow (Y), magenta (M), cyan (C), and black (Bk), and a reaction liquid. The sheet S is sucked and conveyed by the print belt unit 2010, whereby a clearance between the sheet S and the recording heads is ensured.

The number of colors of the ink and the number of recording heads are not limited to five described above. As the inkjet method, a method using a heater element, a method using a piezoelectric element, a method using an electrostatic element, a method using a microelectromechanical system (MEMS) element, or the like may be employed. The ink of each color is supplied from an ink tank (not illustrated) to the corresponding recording head through an ink tube. The ink contains, with the total mass of ink as reference, “0.1 mass % to 20.0 mass %” of resin component, water, a water-soluble organic solvent, a color material, wax, an additive, and the like.

The sheet S on which the image has been formed by the recording unit 2020 is subjected to detection of deviation and color density of the formed image by an inline scanner (not illustrated) disposed on a downstream side of the recording unit 2020 in the sheet conveyance direction while being conveyed by the print belt unit 2010. Based on deviation and color density of the image, the image to be formed on the sheet S, density, and the like are corrected.

The drying module 3000 includes a decoupling unit 3200, a drying belt unit 3300, and a hot air blowing unit 3400. To enhance fixation of the ink to the sheet S by the subsequent module, which is the fixing module 4000, the drying module 3000 reduces liquid components of the ink and the reaction liquid applied to the sheet S. The sheet S on which the image has been formed is conveyed to the decoupling unit 3200 disposed inside the drying module 3000. In the decoupling unit 3200, frictional force is generated between the sheet S and the belt by air pressure of the air blown from above, and the sheet S is conveyed by the belt. The sheet S placed on the belt is conveyed by the frictional force in the above described manner, which prevents deviation of the sheet S when the sheet S is conveyed over the print belt unit 2010 and the decoupling unit 3200. The sheet S conveyed from the decoupling unit 3200 is sucked and conveyed by the drying belt unit 3300. The hot air is blown to the sheet S from the hot air blowing unit 3400 disposed above the belt, to dry the ink and the reaction liquid applied to the sheet S.

The ink and the reaction liquid applied to the sheet S are heated, and evaporation of moisture is accelerated by the drying module 3000. As a result, it is possible to suppress occurrence of so-called cockling in which the sheet S is locally stretched and wrinkled by absorbing the applied ink. As the drying module 3000, any apparatus may be used as long as the apparatus may perform heating and drying, and for example, a hot air dryer or a heater are usable. As the heater, heating is realized by, for example, a heating wire or an infrared heater from the viewpoint of safety and energy efficiency. In addition to the method of applying the hot air, the drying method may be realized by combining a method of irradiating the surface of the sheet with electromagnetic waves (such as ultraviolet rays and infrared radiation) and a conductive heat transfer method using contact with a heating element.

The fixing module 4000 includes a fixing belt unit 4100. The fixing belt unit 4100 receives the sheet S conveyed from the drying module 3000, causes the sheet S to pass through between a heated upper belt unit and a heated lower belt unit to fix the ink to the sheet S, and then delivers the sheet S to the cooling module 5000. The fixing belt unit 4100 is described in detail below.

The cooling module 5000 includes a plurality of cooling units 5100, and the cooling units 5100 cool the high-temperature sheet S conveyed from the fixing module 4000. For example, each of the cooling units 5100 takes outside air into a cooling box by a fan to increase pressure inside the cooling box, and applies air blown out from the cooling box through a nozzle by pressure to the sheet S, to cool the sheet S. The cooling units 5100 are disposed on both sides of the conveyance path of the sheet S, to cool both surfaces of the sheet S.

The cooling module 5000 includes a conveyance path switching unit 5002. The conveyance path switching unit 5002 switches the conveyance path of the sheet S based on a case where the sheet S is conveyed to the reversing module 6000 and a case where the sheet S is conveyed to a duplex conveyance path for duplex printing in which images are formed on both surfaces of the sheet S.

The reversing module 6000 includes a reversing unit 6400. The reversing unit 6400 reverses the front and back sides of the conveyed sheet S to change the orientation of the sheet S when the sheet S is discharged to the stacking module 7000. The stacking module 7000 includes a top tray 7200 and a stacking unit 7500 on which the sheet S conveyed from the reversing module 6000 is stacked.

In duplex printing, the sheet S is conveyed to the conveyance path at a lower part of the cooling module 5000 by the conveyance path switching unit 5002. Thereafter, the sheet S is returned to the print module 2000 through the duplex conveyance path of the fixing module 4000, the drying module 3000, the print module 2000, and the sheet feeding module 1000. A reversing unit 4200 reversing the front and back sides of the sheet S is provided in a duplex conveyance unit of the fixing module 4000. An image is formed on the other surface on which no image has been formed, of the sheet S returned to the print module 2000, by using the ink. Then, the resultant sheet S is discharged to the stacking module 7000 through the drying module 3000, the fixing module 4000, the cooling module 5000, and the reversing module 6000.

### One or More Embodiments of a Fixing Module

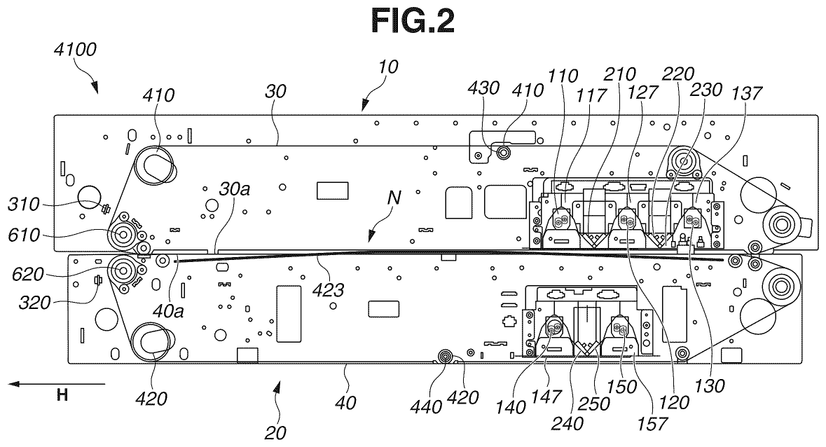

The fixing module 4000 is described with reference to FIG. 2. As illustrated in FIG. 2, the fixing module 4000 includes an upper belt unit 10 and a lower belt unit 20. The sheet S is held and conveyed by the upper belt unit 10 and the lower belt unit 20. During the conveyance, pressure and heat is applied to the sheet S, and the image formed by the ink is fixed to the sheet S.

The upper belt unit 10 is disposed above the lower belt unit 20 in a vertical direction. The upper belt unit 10 includes an upper belt 30 serving as a first belt, a plurality of stretching rollers rotatably stretching the upper belt 30, heating units 117, 127, and 137 heating the upper belt 30, an upper belt temperature sensor 310 serving as a temperature detection unit (first temperature detection unit) that detects a temperature of the upper belt 30, and upper heater temperature sensors 210, 220, and 230. The lower belt unit 20 includes a lower belt 40 serving as a second belt, a plurality of stretching rollers rotatably stretching the lower belt 40, heating units 147 and 157 heating the lower belt 40, a lower belt temperature sensor 320 (second temperature detection unit) that detects a temperature of the lower belt 40, lower heater temperature sensors 240 and 250, and a pad 423. The pad 423 is disposed to form a fixing nip portion N with the upper belt 30 via the lower belt 40.

The sheet S is held and conveyed at the fixing nip portion N formed by the upper belt unit 10 and the lower belt unit 20. Pressure of the fixing nip portion N is determined by tension and a thickness of the upper belt 30, and a curvature of the pad 423. If the pressure of the fixing nip portion N is excessively high, the ink of the sheet S may adhere to the upper belt unit 10, and the ink may be peeled from the sheet S. Therefore, the pressure is set to “more than or equal to 1 Pa and less than or equal to 2000 Pa”, or more desirably, “more than or equal to 1 Pa and less than or equal to 200 Pa”.

If the curvature of the pad 423 is set excessively large, a conveyance path difference between the front and back sides of the sheet S becomes large, and the sheet S may be rubbed with the upper belt 30 when passing through the fixing nip portion N. Alternatively, if the curvature of the pad 423 is set to be excessively large, the sheet S may be curled along a curved surface shape of the pad 423. To prevent such phenomena, a radius of curvature of the pad 423 is set to more than or equal to “5000 millimeters (mm)”. In terms of manufacturing accuracy, the radius of curvature of the pad 423 is set to less than or equal to “100000 mm”. Therefore, in one or more embodiments, the tension of the upper belt 30 is set to “200 N”, the thickness of the upper belt 30 is set to “0.3 mm”, the radius of curvature of the pad 423 is set to “30000 mm”, and the pressure of the fixing nip portion N is set to “about 16 Pa”.

With this configuration, in a case where the fixing nip portion N which is long in the sheet conveyance direction (direction of arrow H) is formed, the sheet S passing through the fixing nip portion N may be uniformly pressurized. As a result, a contact time between the sheet S and the upper belt 30 is ensured in a state where the temperature of the upper belt 30 is set to a melting point of wax included in the ink or a boiling point of water. Thus, the sheet S is sufficiently heated.

However, if the sufficiently heated sheet S is continuously conveyed through the fixing nip portion N, the ink may be peeled from the sheet S and adhere to the upper belt 30, or the upper belt 30 and the sheet S may be rubbed with each other which causes the image to be disturbed. Thus, it is necessary to limit a time during which the sheet S passes through the fixing nip portion N. For example, a time after a leading edge of the sheet S enters an inlet of the fixing nip portion N until a trailing edge of the sheet S exits from an outlet of the fixing nip portion N is set to “0.5 seconds to 4 seconds”. In at least one embodiment, as an example, the pad 423 having a length in the sheet conveyance direction of “900 mm” is used, a conveyance speed of the sheet S is set to “700 millimeter/seconds (mm/s)”, and a passing time of the sheet S passing through the fixing nip portion N is set to “about 1.3 seconds”.

To penetrate the ink into the sheet S, moisture is necessary. Therefore, it is desirable that the upper belt 30 and the lower belt 40 be impermeable to moisture, in order to prevent the moisture evaporated from the surface of the heated sheet S from escaping through the upper belt 30 or the lower belt 40. In at least one embodiment, in consideration of heat resistance, slidability, sealability, and durability, an endless belt of a glass fiber base material having a surface coating of polytetrafluoroethylene (PTFE) and having a thickness of “about 0.4 mm” is used as each of the upper belt 30 and the lower belt 40.

Among the plurality of stretching rollers provided in the upper belt unit 10 and the lower belt unit 20, driving rollers 610 and 620 drive the upper belt 30 and the lower belt 40, respectively. When the driving rollers 610 and 620 are rotated by driving motors (not illustrated), the upper belt 30 and the lower belt 40 are rotationally driven by frictional force between roller surfaces and belt inner surfaces.

By rotation of the upper belt 30 and the lower belt 40, driven rollers 430 and 440 are driven and rotated. Rotation detection sensors 410 and 420 are disposed on rotary shafts of the driven rollers 430 and 440, respectively. Each of the rotation detection sensors 410 and 420 is an element including a magnet in which magnetic force is switched in the rotation direction of the corresponding driven roller 430 or 440. The rotation detection sensors 410 and 420 may detect rotation of the upper belt 30 and the lower belt 40, respectively, by detecting a change of an N pole and S pole generated by rotation, by hall sensors (not illustrated). While, in at least one embodiment, each of the rotation detection sensors 410 and 420 is the element including the magnet, for example, a transmissive sensor that detects a change of light shielding and transmission by using a physical flag having an edge in the rotation direction of the corresponding driven roller 430 or 440 may be used.

The upper belt unit 10 includes the heating units 117, 127 and 137 each including a plurality of heaters, and the lower belt unit 20 includes the heating units 147 and 157 each including a plurality of heaters. The heating units 117, 127, and 137 of the upper belt unit 10 are disposed on a side with the fixing nip portion N of the upper belt unit 10, and each include the heaters for heating the upper belt 30 from an inner peripheral side. The heating units 117, 127, and 137 directly heat portions of the upper belt 30 corresponding to the fixing nip portion N, whereby heat is efficiently transferred to the sheet S. In each of the heating units 117, 127, and 137, voltages to be supplied to the heaters are controlled based on a detection result of the upper belt temperature sensor 310 detecting the temperature of the upper belt 30. Thus, the temperatures of the heaters are adjusted such that the temperature of the upper belt 30 becomes a predetermined target temperature.

The heating units 147 and 157 of the lower belt unit 20 are disposed on a side opposite to the side with the fixing nip portion N of the lower belt unit 20, and each include the heaters for heating the lower belt 40 from an inner peripheral side. Since the pad 423 is provided on the side with the fixing nip portion N of the lower belt unit 20, it is not possible to dispose the heating units 147 and 157 on the side with the fixing nip portion N and to directly heat portions of the lower belt 40 corresponding to the fixing nip portion N. Therefore, the heating units 147 and 157 are disposed at positions close to the inlet of the fixing nip portion N as much as possible along the lower belt 40 on the side opposite to the fixing nip portion N side, whereby heat is efficiently transferred to the sheet S through the lower belt 40. In each of the heating units 147 and 157, voltages to be supplied to the heaters are controlled based on a detection result of the lower belt temperature sensor 320 detecting the temperature of the lower belt 40. Thus, the temperatures of the heaters are adjusted such that the temperature of the lower belt 40 becomes a predetermined target temperature.

Each of the target temperature of the upper belt 30 and the target temperature of the lower belt 40 is set to a predetermined temperature for each of the following conditions: a standby state, a state where an image is formed on plain paper (normal state), a state where an image is formed on the sheet S (e.g., thin paper) having a basis weight less than a basis weight of the plain paper, and a state where an image is formed on the sheet S (e.g., cardboard) having a basis weight greater than the basis weight of the plain paper. For example, during image formation for the plain paper, each of the target temperature of the upper belt 30 and the target temperature of the lower belt 40 is set to “95° C.” that is a reference target temperature. In the standby state where image forming operation on the sheet S may be immediately started, each of the target temperatures is set to “95° C.” that is the same temperature as in the image formation for the plain paper. During image formation for the sheet S (e.g., thin paper) having the basis weight less than the basis weight of the plain paper, each of the target temperatures is set to be “more than or equal to 85° C. and less than or equal to 95° C.” that is a temperature lower than the temperature during the image formation for the plain paper, based on the basis weight. During image formation for the sheet S (e.g., cardboard) having the basis weight greater than the basis weight of the plain paper, each of the target temperatures is set to be “more than or equal to 105° C.” that is a temperature higher than the temperature during the image formation for the plain paper, based on the basis weight.

In a case where the rotation detection sensors 410 and 420 respectively detects rotation stop of the upper belt 30 and the lower belt 40, voltage supply to the heaters is stopped, and heating by the heating units 117, 127, and 137 and the heating units 147 and 157 is stopped. This prevents local heating to the upper belt 30 and the lower belt 40 in a state where the upper belt 30 and the lower belt 40 are stopped.

### One or More Embodiments of a Heating Unit

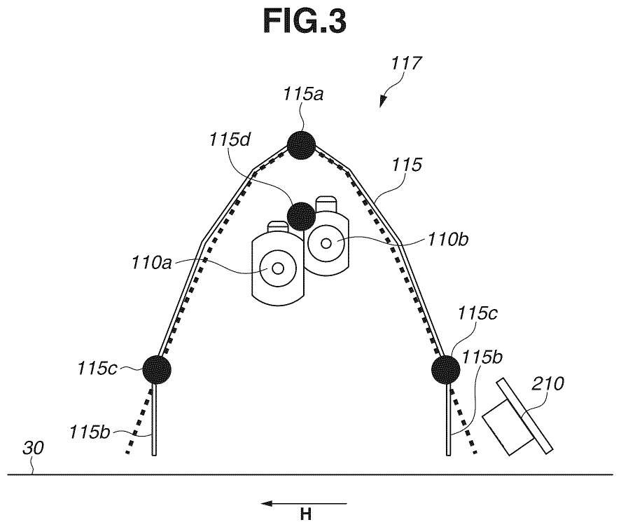

A configuration of each of the above-described heating units (117, 127, 137, 147, and 157) is described with reference to FIG. 3. The heating units 117, 127, and 137 of the upper belt unit 10 and the heating units 147 and 157 of the lower belt unit 20 each have a similar configuration. Therefore, the heating unit 117 of the upper belt unit 10 is described below as a representative example.

As illustrated in FIG. 3, the heating unit 117 includes two heaters 110a and 110b, and a reflector 115. The two heaters 110a and 110b are, for example, halogen heaters that emit infrared radiation to generate heat by being turned on, and are formed in a long shape extending in a belt width direction intersecting the sheet conveyance direction (direction of the arrow H). Both ends of each of the heaters 110a and 110b are supported by supporting portions (not illustrated). It is desirable that the heaters 110a and 110b be halogen heaters different in maximum voltage, namely, heat generation temperature.

The heaters 110a and 110b are covered with the reflector 115. The reflector 115 reflects heat (infrared radiation) generated from the heaters 110a and 110b to heat an inner peripheral surface of the upper belt 30 just below the heaters 110a and 110b. To efficiently heat the upper belt 30, for example, a mirror-finished aluminum member is used for the reflector 115, and the reflector 115 is formed in a parabolic shape that includes a part of a parabola having a reflector vertex 115a as a vertex. The parabolic shape formed from the reflector vertex 115a toward the upper belt 30 is a shape that extends up to reflector parabola end points 115c and includes reflector straight portions 115b extending from the reflector parabola end points 115c toward the inner peripheral surface of the upper belt 30 in a substantially vertical direction. In a case where the reflector 115 is formed in the above-described parabolic shape, the reflector 115 may be formed in a polygonal shape including a plurality of line segments, approximated to the parabolic shape in terms of restriction on manufacture of parts. The reflector straight portions 115b are shortened as much as possible, or may not be provided. However, when the reflector straight portions 115b are provided, a space where the upper heater temperature sensor 210 described below is disposed may be easily ensured.

The heaters 110a and 110b are both disposed at positions close to the upper belt 30 relative to a reflector focal point 115d (focal point of parabola) derived from the reflector vertex 115a and the reflector parabola end points 115c. The heaters 110a and 110b are disposed at different height positions in an up-down direction. The heater 110a having the higher maximum voltage, namely, a higher heat generation temperature is disposed at a position on a lower side close to the upper belt 30, in comparison with the heater 110b having the lower maximum voltage, namely, a lower heat generation temperature. By arranging the heaters 110a and 110b at the positions close to the upper belt 30 relative to the reflector focal point 115d, a rate at which the heat generated from the heaters 110a and 110b is reflected by the reflector 115 may be reduced, which may enhance heating efficiency of the upper belt 30. By arranging the two heaters 110a and 110b at the different height positions in the up-down direction, it is possible to introduce a difference in the manner of thermal distribution imbalance when each of the heaters 110a and 110b is individually turned on. This makes it possible to prevent local concentration of the heat when the two heaters 110a and 110b are turned on at the same time.

### One or More Embodiments of a Heater Temperature Sensor

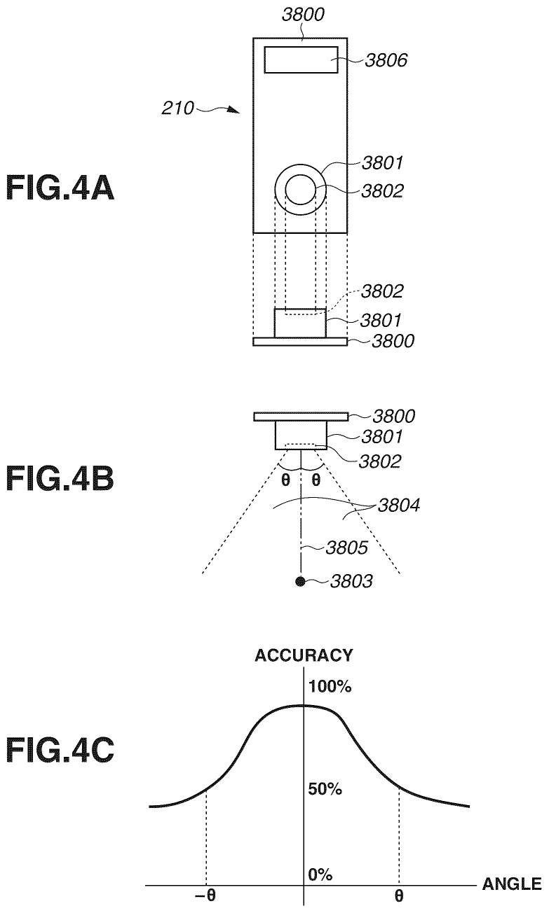

Each of the heater temperature sensors (210 to 250) is described with reference to FIG. 3 and FIGS. 4A to 4C. FIG. 4A is a diagram illustrating a configuration of the heater temperature sensor, where an upper part is a top view and a lower part is a side view. FIG. 4B is a diagram illustrating a viewing angle of the heater temperature sensor. FIG. 4C is a diagram illustrating relationship between temperature measurement accuracy and the viewing angle. To facilitate understanding of the description, the upper heater temperature sensor 210 is described below as a representative example. Each of the other heater temperature sensors (220, 230, 240, and 250) is similar to the upper heater temperature sensor 210. Thus, the redundant description is omitted.

As illustrated in FIG. 3, the upper heater temperature sensor 210 is disposed in proximity to an outside of the reflector 115 because the upper heater temperature sensor 210 detects a temperature of a belt area of the upper belt 30 heated by the heaters 110a and 110b. The upper heater temperature sensor 210 detects the temperature of the belt area heated by the heaters 110a and 110b. The upper heater temperature sensor 210 is disposed as a safety sensor that stops heating by the heaters 110a and 110b in a case where the temperature of the belt area (referred to as belt temperature) detected by the upper heater temperature sensor 210 is, for example, more than or equal to “200° C.”.

The above-described temperature “200° C.” is an upper limit temperature for preventing the upper belt 30 from being thermally deformed, and is previously set based on a material of the upper belt 30. In a case where the upper belt 30 is normally rotated, the temperature of the belt area is usually maintained at less than or equal to “about 130° C.”. Therefore, the upper heater temperature sensor 210 does not detect more than or equal to “200° C.”. If rotation of the upper belt 30 is stopped due to failure or the like in the state where the heaters 110a and 110b perform heating, and further, the rotation detection sensor 420 may not detect rotation stop of the upper belt 30, the heaters 110a and 110b locally continuously heat the same portion of the upper belt 30 having stopped. Consequently, the temperature of the heated portion becomes high. Therefore, the upper heater temperature sensor 210 is caused to detect the temperature of the portion (belt area), so that even when rotation stop unintended by a user occurs on the upper belt 30, the heaters 110a and 110b are immediately stopped before the upper belt 30 becomes high temperature and is thermally deformed, to prevent the upper belt 30 from being thermally deformed and damaged.

As illustrated in FIG. 4A, in the upper heater temperature sensor 210, a package 3801 including a sensor module (not illustrated) is mounted on a substrate 3800. In at least one embodiment, the package 3801 is disposed at the end-most part of the substrate 3800 among parts mounted on the substrate 3800. A surface of the package 3801 on a side opposite to the side with the substrate 3800 serves as a detection surface, and the detection surface includes a detection window 3802 allowing infrared radiation to pass therethrough. The upper heater temperature sensor 210 absorbs the infrared radiation radiated from the upper belt 30 to be measured, through the detection window 3802, converts energy of the absorbed infrared radiation into an electric signal by the sensor module, whereby non-contact temperature detection is performed. Further, the upper heater temperature sensor 210 may output the electric signal converted by the sensor module, from a connector 3806.

The detection window 3802 not only allows infrared radiation to pass therethrough to the inside of the package 3801 but also serves as a lens. As illustrated in FIG. 4B, the upper heater temperature sensor 210 has a certain viewing angle 3804, and detects a temperature of a measurement object 3803 inside the viewing angle 3804 in a non-contact manner. When the measurement object 3803 is present on a center line 3805 of the viewing angle 3804 as illustrated in FIG. 4C, temperature measurement accuracy is set to be “100%”. The measurement object 3803 is moved leftward or rightward from the center line 3805 without changing an interval between the measurement object 3803 and the upper heater temperature sensor 210. In at least one embodiment, an angle θ formed by the measurement object 3803 and the center line 3805 at which the temperature measurement accuracy is lowered to “50%” due to movement is defined as the viewing angle 3804. Here, the angle θ at which the temperature measurement accuracy is lowered to “50%” is defined as the viewing angle 3804, but this is illustrative, and the temperature measurement accuracy is not limited to “50%”. The viewing angle 3804 may be the angle θ, for example, at which the temperature measurement accuracy is lowered to “40%” or at which the temperature measurement accuracy is lowered to “60%”.

### One or More Embodiments of a Heater

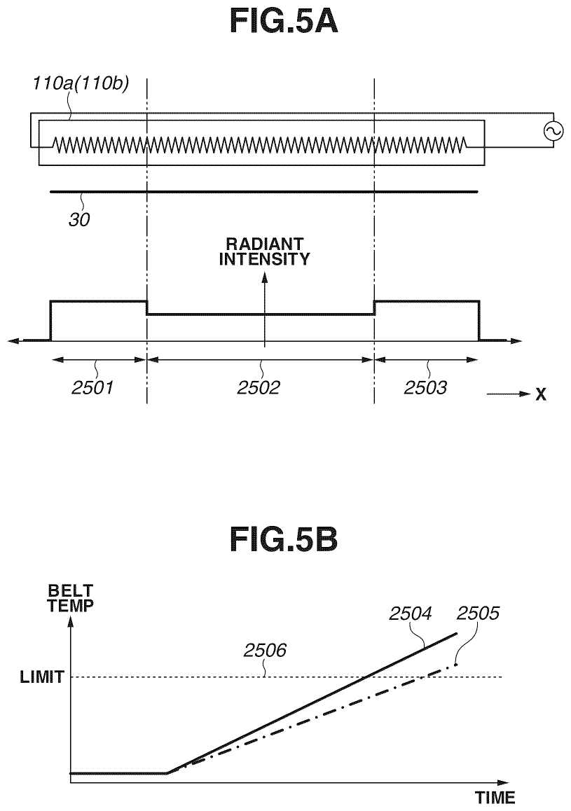

The heater 110a (110b) is described with reference to FIG. 5A and FIG. 5B. FIG. 5A is a diagram illustrating heating intensity of the heater 110a (110b) at each position in the belt width direction, where an upper part illustrates a case where the heater 110a (110b) and the upper belt 30 are viewed from an upstream side to a downstream side in the sheet conveyance direction, and a lower part illustrates heating intensity of the heater 110a (110b) at each position in the belt width direction. The belt width direction is a direction intersecting the sheet conveyance direction, and is illustrated by an arrow X in the drawing. As illustrated in FIG. 5A, in at least one embodiment, to suppress heating unevenness in the belt width direction, the infrared radiation emitted from the heater 110a (110b) are distributed such that heating intensity in belt end areas 2501 and 2503 is higher than heating intensity in a belt center area 2502.

FIG. 5B is a diagram illustrating a change over time of the belt temperature in a case where the upper belt 30 is continuously heated by the heater 110a (110b). A lateral axis indicates a time, and a vertical axis indicates a belt temperature. A solid line 2504 indicates temperature rise in the belt end areas 2501 and 2503, and an alternate long and short dash line 2505 indicates temperature rise in the belt center area 2502. As described above, since the infrared radiation emitted from the heater 110a (110b) are distributed such that the heating intensity in the belt end areas 2501 and 2503 is higher than the heating intensity in the belt center area 2502, the temperature in the belt end areas 2501 and 2503 indicated by the solid line 2504 rises with a large gradient as compared with the belt center area 2502 indicated by the alternate long and short dash line 2505. A dashed line 2506 illustrated in the drawing indicates the above-described upper limit temperature (e.g., 200° C.) for preventing the upper belt 30 from being thermally deformed. A threshold for immediately stopping the heaters 110a and 110b is set such that the upper belt 30 does not exceed the upper limit temperature indicated by the dashed line 2506.

### One or More Embodiments of a Heater Temperature Control System

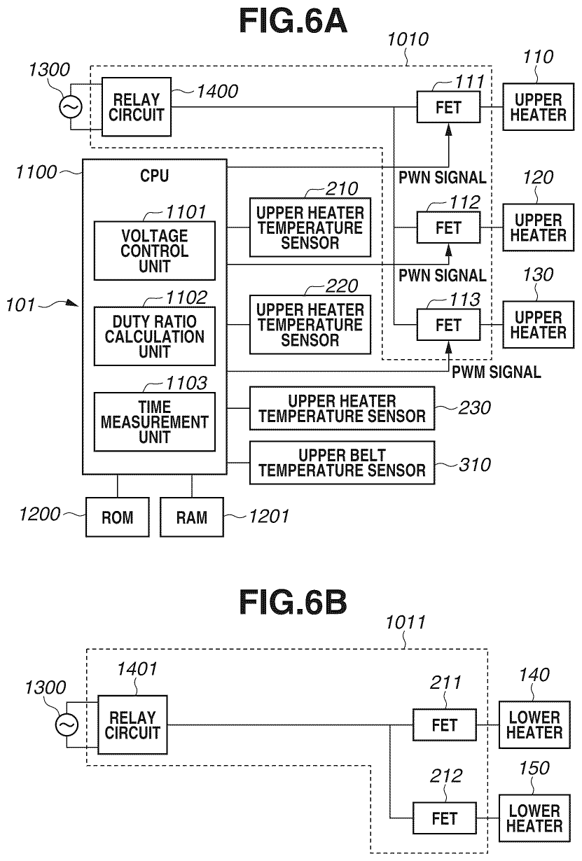

A temperature control system that controls the temperatures of upper heaters 110, 120, and 130 of the upper belt unit 10 and the temperatures of lower heaters 140 and 150 of the lower belt unit 20 is described with reference to FIG. 2 and FIGS. 6A and 6B. The inkjet recording apparatus 1 according to at least one embodiment includes a heater control unit 101 that controls the temperatures of the upper heaters 110, 120, and 130 serving as heating elements (first heating elements) and the temperatures of the lower heaters 140 and 150 serving as second heating elements.

In at least one embodiment, the upper belt unit 10 and the lower belt unit 20 have a similar configuration except that the upper belt unit 10 includes the three heating units (117, 127, and 137) and the lower belt unit 20 includes the two heating units (147 and 157), and the lower belt unit 20 includes the pad 423. Therefore, to facilitate understanding of the description, the upper belt unit 10 is described below as an example unless otherwise noted.

As illustrated in FIG. 6A, the heater control unit 101 includes a power supply circuit 1010, a central processing unit (CPU) 1100 executing programs for “heater control processing” and the like described below, a read only memory (ROM) 1200 storing the programs, and a random access memory (RAM) 1201 serving as a work area when the programs are executed. The power supply circuit 1010 includes a relay circuit 1400, and a plurality of field effect transistors (FETs) 111, 112, and 113 provided corresponding to the upper heaters 110, 120, and 130, respectively. The relay circuit 1400 rectifies an alternating-current voltage supplied from an alternating-current power supply 1300, and outputs the rectified alternating-current voltage to the FETs 111, 112, and 113.

The CPU 1100 serving as a control unit performs pulse width modulation (PWM) control based on the detection result of the upper belt temperature sensor 310, to stabilize the temperature of the upper belt 30. The FETs 111, 112, and 113 adjust voltages supplied from the relay circuit 1400 to the upper heaters 110, 120, and 130, respectively, based on PWM signals generated by the CPU 1100. When the FETs 111, 112, and 113 serving as switching elements are turned on and off based on the PWM signals generated by the CPU 1100, the voltages to be supplied to the upper heaters 110, 120, and 130 are adjusted. The FETs 111, 112, and 113 may output the voltages subjected to pulse width modulation based on duty ratios (pulse width/period) of the PWM signals, to the upper heaters 110, 120, and 130, respectively.

The CPU 1100 includes a voltage control unit 1101 that generates and outputs the PWM signals, a duty ratio calculation unit 1102 that calculates the duty ratios of the PWM signals, and a time measurement unit 1103. The duty ratio calculation unit 1102 calculates the duty ratios of the PWM signals to be transmitted to the FETs 111, 112, and 113. The duty ratio calculation unit 1102 calculates target duty ratios through proportional-integral (PI) control from a temperature difference between the temperature of the upper belt 30 detected by the upper belt temperature sensor 310 and the target temperature of the upper belt 30. Larger duty ratios are calculated as the temperature difference between the temperature of the upper belt 30 and the target temperature of the upper belt 30 is larger. The duty ratio calculation unit 1102 then determines a total duty ratio obtained by adding the duty ratios of the PWM signals calculated for the upper heaters 110, 120, and 130 (for heating elements). The total duty ratio reflects the temperature difference between the temperature of the upper belt 30 and the target temperature, and the total duty ratio is larger as the temperature difference between the temperature and the target temperature of the upper belt 30 is larger.

The duty ratio of each of the upper heaters 110, 120, and 130 calculated from the temperature difference between the temperature of the upper belt 30 and the target temperature of the upper belt 30 is less than or equal to “100%”. Therefore, in a case where the three heaters: the upper heaters 110, 120, and 130, are provided, the total duty ratio is “300%” at a maximum. In at least one embodiment, the duty ratios of the upper heaters 110, 120, and 130 calculated from the temperature difference between the temperature of the upper belt 30 and the target temperature of the upper belt 30 are equal to each other.

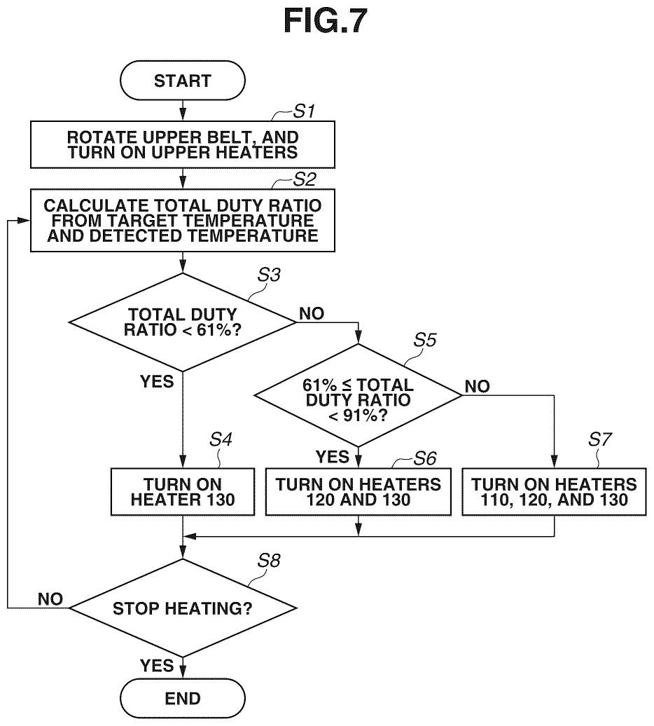

The voltage control unit 1101 determines a heat-generation-operation target heater (turning on target) based on the total duty ratio determined by the duty ratio calculation unit 1102. Although details are described below (see FIG. 7), the voltage control unit 1101 generates and outputs the PWM signal having the duty ratio determined based on the total duty ratio, to the heat-generation-operation target heater among the upper heaters 110, 120, and 130.

On the other hand, the voltage control unit 1101 generates and outputs the PWM signal having the duty ratio of “0%” to the heater other than the heat-generation-operation target heater among the upper heaters 110, 120, and 130. In at least one embodiment, the FETs 111, 112, and 113 receiving the PWM signal having the duty ratio of “0%” are turned off without being on-off controlled based on the PWM signal. Therefore, the upper heaters 110, 120, and 130 corresponding to the FETs 111, 112, and 113 receiving the PWM signal having the duty ratio of “0%” are supplied with no voltage, are not turned on, and do not generate heat. In the present specification, the PWM signal having the duty ratio of “0%” includes a PWM signal having the duty ratio of “0% to 2%” at which the FETs 111, 112, and 113 are not turned on and off.

As illustrated in FIG. 6B, the temperature control system of the lower belt unit 20 includes a power supply circuit 1011 (second power supply circuit) that has a configuration similar to the configuration of the above-described power supply circuit 1010 (first power supply circuit), includes a relay circuit 1401 and a plurality of FETs 211 and 212, and supplies power to the lower heaters 140 and 150. The CPU 1100 may generate and output PWM signals having duty ratios determined based on a total duty ratio relating to the lower heaters 140 and 150, to the plurality of (two) FETs 211 and 212 included in the power supply circuit 1011 based on the detection result of the lower belt temperature sensor 320.

### One or More Embodiments of a Heater Control Processing

The “heater control processing” according to one or more embodiments is described with reference to FIG. 2, FIGS. 6A and 6B, and FIG. 7 to FIG. 10. FIG. 7 is a flowchart of at least one embodiment of a heater control processing according to one or more aspects of the present disclosure. The “heater control processing” is performed by the CPU 1100 in response to turning-on of the inkjet recording apparatus 1.

As illustrated in FIG. 7, in step S1, the CPU 1100 drives a driving motor (not illustrated) of the upper belt 30 to rotate the upper belt 30, and starts heating of the upper belt 30 by the upper heaters 110, 120, and 130. In step S2, the duty ratio calculation unit 1102 of the CPU 1100 adds the duty ratios of the upper heaters 110, 120, and 130 determined based on the temperature difference between the temperature of the upper belt 30 detected by the upper belt temperature sensor 310 and the target temperature of the upper belt 30, to calculate the total duty ratio.

In steps S3 to S7, the CPU 1100 generates and outputs the PWM signals having the duty ratios in accordance with Table 1 described below to the upper heaters 110, 120, and 130 based on the calculated total duty ratio. As illustrated in Table 1, the duty ratio of the PWM signal for the heat-generation-operation target heater is set to be adjusted to more than or equal to “30%” (predetermined value or more) in at least one embodiment.

TABLE 1

| | Control | Upper | Upper | Upper | Lower | Lower |
|---|---|---|---|---|---|---|
| Object | item | heater 110 | heater 120 | heater 130 | heater 140 | heater 150 |
| Upper heaters | Total duty | 0 | 0 | Total | | |
| 110 to 130 | ratio < 61 | | | Ratio | | |
| | 61 ≤ Total duty | 0 | Total | Total | | |
| | ratio < 91 | | ratio/2 | ratio/2 | | |
| | 91 ≤ Total duty | Total | Total | Total | | |
| | ratio ≤ 300 | ratio/3 | ratio/3 | ratio/3 | | |
| Lower heaters | Total duty | | | | 0 | Total |
| 140 and 150 | ratio < 61 | | | | | ratio |
| | 61 ≤ Total duty | | | | Total | Total |
| | ratio ≤ 200 | | | | ratio/2 | ratio/2 |

In a case where the total duty ratio is less than “61%” (YES in step S3), the processing proceeds to step S4. In step S4, the CPU 1100 determines one upper heater 130 among the upper heaters 110 to 130 as the heat-generation-operation target heater based on Table 1. In this case, the CPU 1100 generates the PWM signal in which the duty ratio is set to the “total duty ratio”, and outputs the PWM signal to the FET 113 corresponding to the upper heater 130.

The CPU 1100 generates the PWM signal in which the duty ratio is set to “0%” and outputs the PWM signal to the FET 111 and the FET 112 corresponding to the upper heater 110 and the upper heater 120, respectively. In other words, the CPU 1100 outputs the PWM signals having different duty ratios. Since the upper heaters 110 and 120 receiving the PWM signal having the duty ratio of “0%” are supplied with no voltage, and are not turned on, the upper heaters 110 and 120 do not generate heat, whereas since the upper heater 130 receiving the PWM signal having the “total duty ratio” is supplied with the voltage, and is turned on, the upper heater 130 generates heat.

In step S6, in a case where the total duty ratio is more than or equal to “61%” and less than “91%” (YES in step S5), the CPU 1100 determines two upper heaters 120 and 130 among the upper heaters 110 to 130 as the heat-generation-operation target heaters based on Table 1. In this case, the CPU 1100 generates the PWM signal in which the duty ratio is set to “total duty ratio/2”, namely, “total duty ratio/number of used heaters”, and outputs the PWM signal to the FETs 112 and 113 corresponding to the upper heaters 120 and 130, respectively. The CPU 1100 generates the PWM signal in which the duty ratio is set to “0%”, and outputs the PWM signal to the FET 111 corresponding to the upper heater 110. In other words, the CPU 1100 outputs the PWM signals having different duty ratios. Since the upper heater 110 receiving the PWM signal having the duty ratio of “0%” is supplied with no voltage, the upper heater 110 is not turned on, and does not generate heat, whereas since the upper heaters 120 and 130 receiving the PWM signal having the “total duty ratio/2” are supplied with the voltage, and are turned on, the upper heaters 120 and 130 generate heat.

In a case where the total duty ratio is greater than “91%” (NO in step S5), the processing proceeds to step S7. In step S7, the CPU 1100 determines three upper heaters 110, 120, and 130 among the upper heaters 110 to 130 as the heat-generation-operation target heaters. In this case, the CPU 1100 generates the PWM signal in which the duty ratio is set to “total duty ratio/3 (number of used heaters)”, and outputs the PWM signal to the FETs 111, 112, and 113 corresponding to the upper heaters 110, 120, and 130, respectively. In other words, the CPU 1100 outputs the PWM signals having the same duty ratio. Accordingly, since all the upper heaters 110 to 130 are supplied with the voltage, and are turned on, the upper heaters 110 to 130 generate heat.

In step S8 after the processing in step S4, step S6, or step S7 described above, the CPU 1100 determines whether to stop heating of the upper belt 30 by the upper heaters 110 to 130. In a case where the CPU 1100 determines that heating of the upper belt 30 by the upper heaters 110 to 130 is stopped (YES in step S8), the heater control processing ends. In contrast, in a case where heating of the upper belt 30 by the upper heaters 110 to 130 is not stopped (NO in step S8), the processing returns to step S2, and steps S2 to S8 are performed again.

In the above-described manner, in a case where the temperature difference between the temperature and the target temperature of the upper belt 30 is greater than or equal to the threshold, two of the upper heaters 120 and 130 or more are caused to generate heat, whereas in a case where the temperature difference between the temperature and the target temperature of the upper belt 30 is less than the threshold, the heaters less than the number of heaters in the case where the temperature difference is greater than or equal to the threshold, namely, the upper heater 110 is caused to generate heat. As illustrated in Table 1, the predetermined number of upper heaters 110, 120, and 130 are caused to generate heat based on the temperature difference.

The case where the upper heaters 110, 120, and 130 are controlled is described as an example. The CPU 1100 also performs similar control on the lower heaters 140 and 150 at the same time of the control of the upper heaters 110 to 130 as illustrated in Table 1. In a case where the total duty ratio is less than “61%”, the CPU 1100 determines the lower heater 150 as the heat-generation-operation target heater based on Table 1. In this case, the CPU 1100 generates the PWM signal in which the duty ratio is set to “total duty ratio”, and outputs the PWM signal to the FET 212 corresponding to the lower heater 150. The CPU 1100 generates the PWM signal in which the duty ratio is set to “0%”, and outputs the PWM signal to the FET 211 corresponding to the lower heater 140. In a case where the total duty ratio is more than “61%”, the CPU 1100 determines the lower heaters 140 and 150 as the heat-generation-operation target heaters based on Table 1. In this case, the CPU 1100 generates the PWM signal in which the duty ratio is set to “total duty ratio/2 (number of used heaters)”, and outputs the PWM signal to the FETs 211 and 212 corresponding to the lower heaters 140 and 150, respectively.

### Comparison of One or More Examples/Embodiments

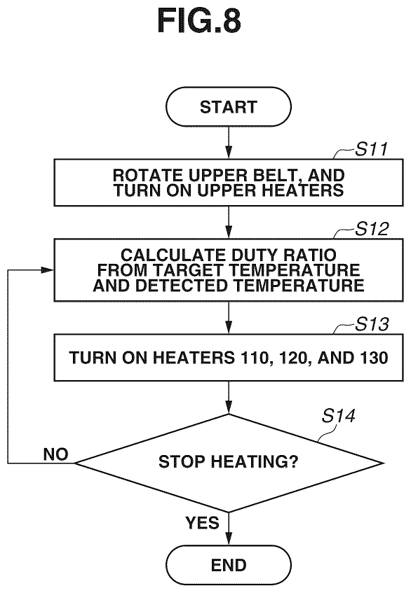

One or more embodiment examples are compared. FIG. 8 is a flowchart illustrating “heater control processing” according to one or more aspects of the present disclosure. The “heater control processing” according to one or more aspects of the present disclosure is performed by a CPU that may perform PWM control in response to turning-on of the inkjet recording apparatus 1.

As illustrated in FIG. 8, in step S11, the CPU drives the driving motor (not illustrated) of the upper belt 30 to rotate the upper belt 30, and starts heating of the upper belt 30 by the upper heaters 110, 120, and 130. In step S12, the CPU calculates the duty ratio of each of the upper heaters 110, 120, and 130 based on the temperature difference between the temperature of the upper belt 30 detected by the upper belt temperature sensor 310 and the target temperature of the upper belt 30. In step S13, the CPU generates the PWM signals in which the duty ratios are set to the determined duty ratios, and outputs the PWM signals to the FETs 111, 112, and 113 corresponding to the upper heaters 110, 120, and 130, respectively. Since all the upper heaters 110 to 130 are supplied with the voltages, all the upper heaters 110 to 130 are turned on and generate heat. Thereafter, in step S14, the CPU determines whether to stop heating of the upper belt 30 by the upper heaters 110 to 130. In a case where heating of the upper belt 30 by the upper heaters 110 to 130 is stopped (YES in step S14), the heater control processing ends. In contrast, in a case where heating of the upper belt 30 by the upper heaters 110 to 130 is not stopped (NO in step S14), the processing returns to step S12, and steps S12 to S14 are performed again.

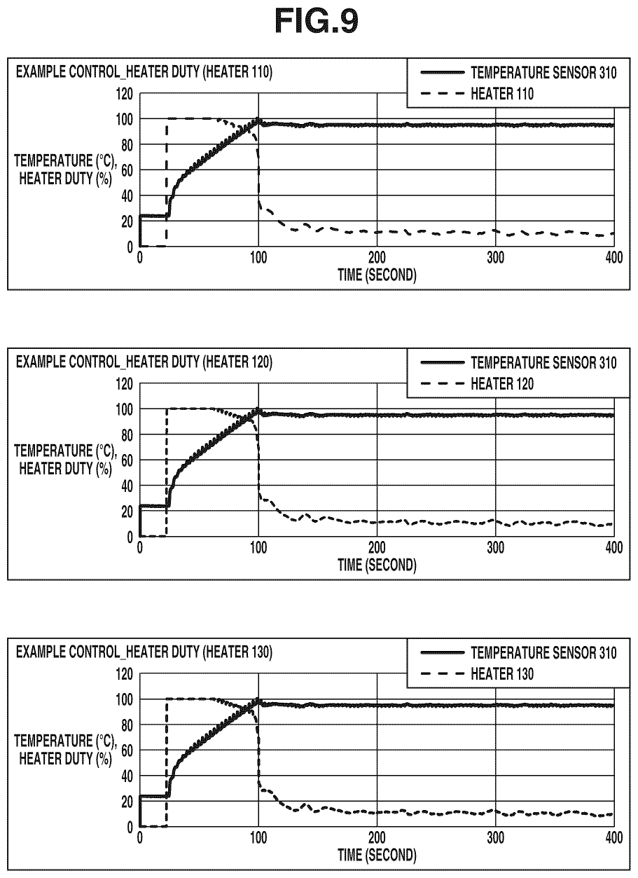

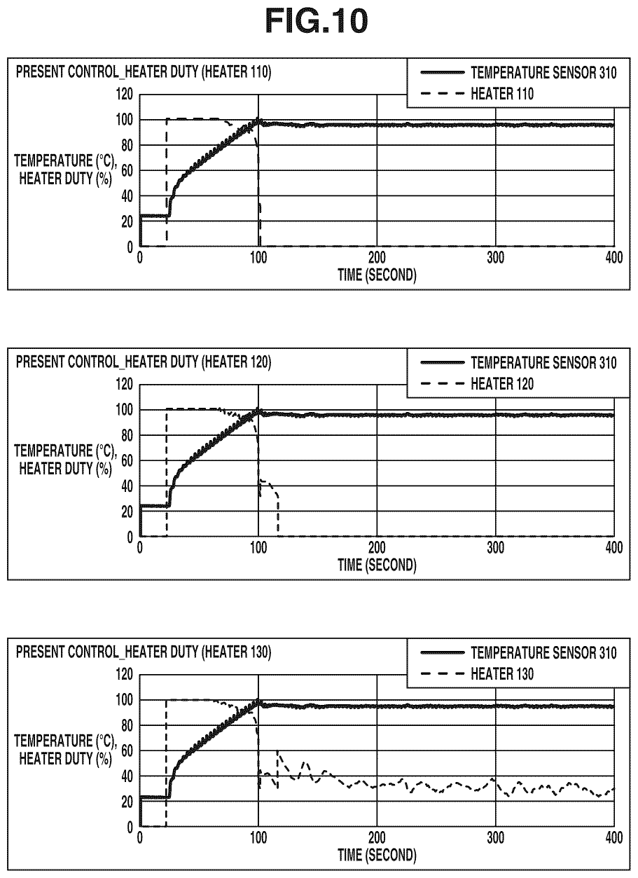

FIG. 9 is a diagram illustrating a change over time of the belt temperature and the duty ratio of the PWM signal output to each heater (more specifically, each FET) according to one or more embodiment examples of the present disclosure. FIG. 10 is a diagram illustrating a change over time of the belt temperature and the duty ratio of the PWM signal output to each heater (more specifically, each FET) according to at least one embodiment. In order from top, a case of the upper heater 110, a case of the upper heater 120, and a case of the upper heater 130 are illustrated.

In FIG. 9 and FIG. 10, the change over time of the belt temperature is indicated by a solid line, and the change over time of the duty ratio of each heater is indicated by a dotted line. In this example, the target temperature of the upper belt 30 is set to “95° C.”.

As illustrated in FIG. 9, until the temperature of the upper belt 30 becomes the target temperature “95° C.”, all the upper heaters 110, 120, and 130 are supplied with the maximum voltages and generate heat because of the PWM signal having the duty ratio of “100%”. However, when the temperature of the upper belt 30 rises with time, and the temperature difference between the temperature and the target temperature of the upper belt 30 exceeds a predetermined threshold, the PWM signal in which the duty ratio is gradually reduced is output to each of the upper heaters 110, 120, and 130 until the temperature of the upper belt 30 reaches the target temperature (100 seconds). In other words, to prevent the temperature of the upper belt 30 from overshooting and exceeding the target temperature, the voltages supplied to the upper heaters 110, 120, and 130 are reduced to reduce the temperature of heat generated from the upper heaters 110, 120, and 130.

In one or more examples, after the temperature of the upper belt 30 reaches the target temperature (after 100 seconds), the PWM signal in which the duty ratio is reduced is continuously output to each of the upper heaters 110, 120, and 130. This is to causes the upper heaters 110, 120, and 130 to generate heat at a relatively low temperature, and to maintain the temperature of the upper belt 30 at the target temperature. For example, the PWM signal having the duty ratio of about “10%” is output. As described above, the temperature adjustment of the upper heaters 110, 120, and 130 are performed by turning on and off the FETs 111, 112, and 113 (see FIGS. 6A and 6B) of the power supply circuit 1010 supplying the voltages, at high speed based on the PWM signals. In other words, in one or more examples, the FETs 111, 112, and 113 are constantly turned on and off at high speed based on the PWM signals, and the upper heaters 110, 120, and 130 are constantly in the heating state. Therefore, service lives of the upper heaters 110, 120, and 130 tend to become short. When the temperature adjustment of the halogen heater is performed by the PWM signal having the duty ratio of less than “30%”, a temperature of a glass tube configuring the halogen heater becomes “250° C.” or less. As a result, tungsten-halogen adheres to a bulb wall and blackening is generated, which may shorten the service life of the halogen heater.

As illustrated in FIG. 10, in at least one embodiment, as in at least one of the aforementioned examples, until the temperature of the upper belt 30 becomes the target temperature “95° C.”, all the upper heaters 110, 120, and 130 are supplied with the maximum voltages and generate heat because of the PWM signal having the duty ratio of “100%”. However, when the temperature of the upper belt 30 rises with time, and the temperature difference between the temperature and the target temperature of the upper belt 30 exceeds the predetermined threshold, the PWM signal in which the duty ratio is gradually reduced is output to each of the upper heaters 110, 120, and 130 until the temperature of the upper belt 30 reaches the target temperature (100 seconds). In other words, to prevent the temperature of the upper belt 30 from overshooting and exceeding the target temperature, the voltages supplied to the upper heaters 110, 120, and 130 are reduced to reduce the temperature of heat generated from the upper heaters 110, 120, and 130.

In at least one embodiment, however, after the temperature of the upper belt 30 reaches the target temperature (after 100 seconds), unlike at least one of the aforementioned examples, the upper heaters 120 and 130 among the upper heaters 110, 120, and 130 each receive the PWM signal having the duty ratio of about “40%”, are supplied with the voltages, and generate heat. At this time, the upper heater 110 receives the PWM signal having the duty ratio of “0%”, is supplied with substantially no voltage, and does not generate heat. Thereafter, only the upper heater 130 receives the PWM signal having the duty ratio of more than or equal to “30%”, is supplied with the voltage, and generates heat. At this time, the upper heaters 110 and 120 each receive the PWM signal having the duty ratio of “0%”, are supplied with substantially no voltage, and do not generate heat. In at least one embodiment, to maintain the temperature of the upper belt 30 at the target temperature, the PWM signal having the duty ratio of more than or equal to “30%” is continuously output to the upper heater 130. In this case, the upper belt 30 is heated with the same heat quantity as in the case where the PWM signal having the duty ratio of about “10%” is output to the upper heaters 110, 120, and 130 in at least one of the aforementioned examples, and the upper belt 30 is maintained at the target temperature.

As described above, in at least one embodiment, in each of the upper belt unit 10 and the lower belt unit 20, to reduce the number of heaters caused to generate heat among the plurality of heaters heating the belt, the PWM signal having the duty ratio of “0%” is output to the heater not caused to generate heat. By outputting the PWM signal having the duty ratio of “0%” to control the power supply circuit 1010, the FETs 111, 112, and 113 are not turned on and off based on the PWM signals, which may prevent the service lives of the upper heaters 110, 120, and 130 from being shortened.

In at least one of the aforementioned examples, even in a case of the low duty ratio less than “30%”, the PWM signal having the low duty ratio is output and the temperature adjustment of the halogen heater is performed, which shortens the service life of the halogen heater. In at least one embodiment, the PWM signal having the low duty ratio less than “30%” is not output, which may further prevent the service life of the halogen heater from being shortened.

While, in one or more of the above-described embodiments, the upper heater 130 and the lower heater 150 that are disposed on the most upstream side in the sheet conveyance direction are prioritized to be turned on (see Table 1), the upper heater 110 and the lower heater 140 that are disposed on the most downstream side may be prioritized to be turned on. While, in the case where the total duty ratio is more than or equal to “61%”, the PWM signals having the same duty ratio (total duty ratio/number of used heaters) are generated and output to the heat-generation-operation target heaters, the PWM signals having the different duty ratios may be generated and output to the heaters.

### One or More Additional Embodiments

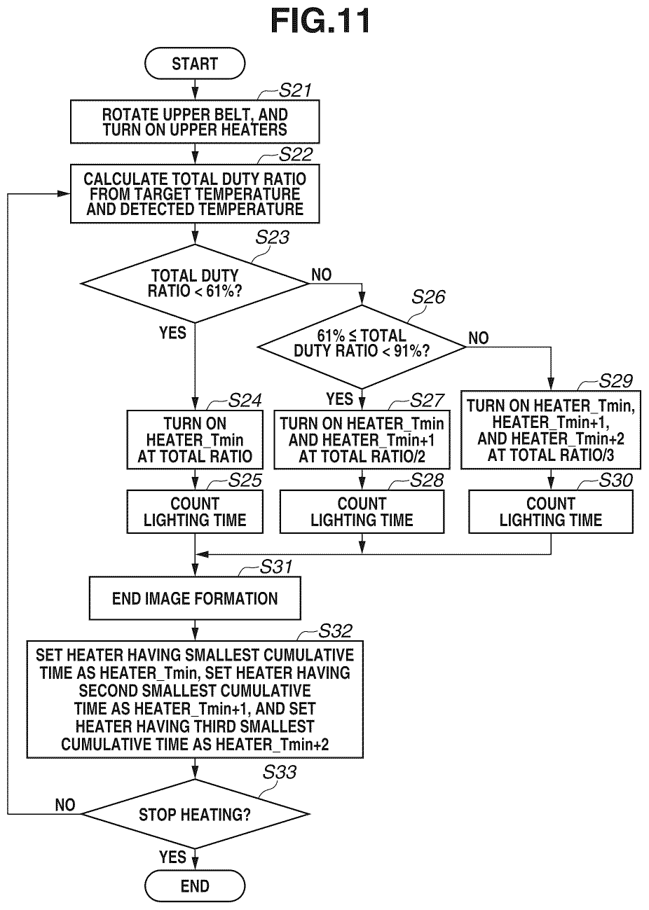

“Heater control processing” according to one or more additional embodiments is described with reference to FIGS. 6A and 6B and FIG. 11. In the case of the “heater control processing” (see FIG. 7) according to the above-described one or more embodiments, since the upper heater 130 and the lower heater 150 are prioritized to be turned on (see Table 1), the upper heater 130 and the lower heater 150 are greater in cumulative lighting time than the other heaters (110, 120, and 140), and are early deteriorated as compared with the other heaters. Therefore, in the one or more additional embodiments, the upper heaters 110, 120, and 130 and the lower heaters 140 and 150 are averagely turned on, and are caused to be deteriorated in a similar manner. As a result, the lives of the plurality of heaters end at the substantially same timing, which enables the user to perform maintenance and replacement of the plurality of heaters at the same timing. The case where the upper heaters 110, 120, and 130 are controlled is described as an example.

As illustrated in FIG. 11, in step S21, the CPU 1100 drives the driving motor (not illustrated) of the upper belt 30 to rotate the upper belt 30, and starts heating of the upper belt 30 by the upper heaters 110, 120, and 130. In step S22, the CPU 1100 adds the duty ratios of the upper heaters 110, 120, and 130 determined based on the temperature difference between the temperature of the upper belt 30 detected by the upper belt temperature sensor 310 and the target temperature of the upper belt 30, to calculate the total duty ratio.

In a case where the total duty ratio is less than “61%” (YES in step S23), the processing proceeds to step S24. In step S24, the CPU 1100 generates the PWM signal having the total duty ratio (total ratio) and outputs the PWM signal to the heater (heater_Tmin) having the smallest cumulative time among the upper heaters 110 to 130. In other words, among the upper heaters 110 to 130, one heater is supplied with the voltage, is turned on, and generates heat. In step S25, the time measurement unit 1103 of the CPU 1100 counts a lighting time of the one heater to which the PWM signal has been output, and measures the cumulative time of the one heater to which the PWM signal has been output. Thereafter, the processing proceeds to step S31.

In a case where the total duty ratio is more than or equal to “61%” and less than “91%” (YES in step S26), the processing proceeds to step S27. In step S27, the CPU 1100 generates the PWM signal having “total duty ratio (total ratio)/2 (number of used heaters)” and outputs the PWM signal to heaters having the first and second smallest cumulative times (heater_Tmin and heater_Tmin+1) among the upper heaters 110 to 130. In other words, among the upper heaters 110 to 130, two heaters are supplied with the voltages, are turned on, and generate heat. In step S28, the time measurement unit 1103 of the CPU 1100 counts the lighting time of each of the two heaters to which the PWM signal has been output, and measures the cumulative time of each of the two heaters to which the PWM signal has been output. Thereafter, the processing proceeds to step S31.

In a case where the total duty ratio is greater than “91%” (NO in step S26), the processing proceeds to step S29. In step S29, the CPU 1100 generates the PWM signal having “total duty ratio (total ratio)/3 (number of used heaters)” and outputs the PWM signal to all the upper heaters 110 to 130 (heater_Tmin, Heater_Tmin+1, and heater_Tmin+2). In other words, all the upper heaters 110 to 130 are supplied with voltages, are turned on, and generate heat. In step S30, the time measurement unit 1103 of the CPU 1100 counts the lighting time of each of the three heaters to which the PWM signal has been output, and measures the cumulative time of each of all the heaters to which the PWM signal has been output. Thereafter, the processing proceeds to step S31.

In step S31, the image formation ends, and in step S32, the CPU 1100 sets a turning-on order of the upper heaters 110 to 130 based on the cumulative time of each of the heaters. In this processing, the CPU 1100 assigns the upper heaters 110 to 130 to any of a first-priority heater (heater_Tmin) to be turned on first, a second-priority heater (heater_Tmin+1) to be turned on next, and a third-priority heater (heater_Tmin+2) to be turned on last, in ascending order of the heaters' cumulative lighting time.

Then, in step S33, the CPU 1100 determines whether to stop heating of the upper belt 30 by the upper heaters 110 to 130. In a case where the CPU 1100 determines that heating of the upper belt 30 by the upper heaters 110 to 130 is stopped (YES in step S33), the heater control processing ends. In n a case where the CPU 1100 determines that heating of the upper belt 30 by the upper heaters 110 to 130 is not stopped (NO in step S33), the processing returns to step S22, and steps S22 to S32 are performed again.

In a case where each of the heaters is turned on at a low duty ratio in counting of the lighting time of each of the heaters in step S25, S28, or S30, even when the lighting time is equal to the lighting time in a case where each of the heaters is turned on at a high duty ratio, a time smaller than the actually-counted lighting time may be measured as the cumulative time. In other words, the CPU 1100 may measure the cumulative time by weighting the counted time based on the duty ratio of the PWM signal.

As described above, in the one or more additional embodiments, as in the above-described one or more embodiments, the power supply circuit 1010 is controlled by using the PWM signal having the duty ratio of “0%” for the heater that is not caused to generate heat. Thus, the FETs 111, 112, and 113 are not turned on and off, which may prevent the service lives of the upper heaters 110, 120, and 130 from being shortened. Further, in the one or more additional embodiments, since the heater less used is prioritized to be used based on the cumulative time, the lives of the plurality of heaters end at the substantially same timing, which enables the user to perform maintenance and replacement of the plurality of heaters at the same timing.

According to the present disclosure, in the configuration in which the ink is fixed to the sheet by using the belt, among the plurality of heating elements heating the belt, the number of heating elements caused to generate heat is reduced, which makes it possible to operate each of the heating elements at a temperature suitable for use.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims priority to and the benefit of Japanese Patent Application No. 2024-184916, filed Oct. 21, 2024, which is hereby incorporated by reference herein in its entirety.

What is claimed is:

1. An inkjet recording apparatus comprising:
an image forming unit that operates to form an image on a sheet by ejecting ink;
a first belt having an endless configuration;
a second belt having an endless configuration and that operates to be in contact with the first belt to form a nip portion, the nip portion holding, conveying, and heating the sheet on which the image has been formed by the image forming unit;
a plurality of heating elements disposed on an inner peripheral side of the first belt along a sheet conveyance direction, and operating to heat the first belt;
a power supply that operates to supply power to the plurality of heating elements;
a temperature detection unit that operates to detect a temperature of the first belt; and
a control unit that operates to individually control power to be supplied to the plurality of heating elements to cause the temperature of the first belt detected by the temperature detection unit to be adjusted to a predetermined target temperature,
wherein, in a case where the power is supplied to the plurality of heating elements, the control unit further operates to control a number of heating elements to which the power is to be supplied, and to cause a duty of one heating element to exceed a first duty and to be less than a second duty greater than the first duty.

2. The inkjet recording apparatus according to claim 1, wherein to adjust the temperature of the first belt detected by the temperature detection unit to be the predetermined target temperature, the control unit further operates to generate, for each of the plurality of heating elements, a plurality of pulse width modulation (PWM) signals for controlling the power supply by pulse width modulation, and to individually control the power to be supplied from the power supply to the plurality of heating elements by the plurality of generated PWM signals.

3. The inkjet recording apparatus according to claim 2, wherein the control unit generates the plurality of PWM signals having different duty ratios, based on at least a temperature difference between the temperature of the first belt and the target temperature.

4. The inkjet recording apparatus according to claim 3, wherein the control unit further operates to cause a predetermined number of the plurality of heating elements to generate heat, based on the temperature difference.

5. The inkjet recording apparatus according to claim 2, wherein the control unit generates the PWM signals having a duty ratio of “0%” for a heating element that is not to be caused to generate heat among the plurality of heating elements.

6. The inkjet recording apparatus according to claim 2, wherein the control unit generates the PWM signals having a same duty ratio for heating elements that are to be caused to generate heat among the plurality of heating elements.

7. The inkjet recording apparatus according to claim 1, wherein the control unit further operates to perform control to supply power to more heating elements within a range where a duty of one heating element exceeds the first duty and is less than the second duty greater than the first duty.

8. The inkjet recording apparatus according to claim 1, wherein the first duty is more than or equal to “30%”.

9. The inkjet recording apparatus according to claim 1, further comprising a time measurement unit that operates to measure a cumulative time by counting a time during which heat is generated for each of the plurality of heating elements,
wherein the plurality of heating elements is caused to generate heat in order from a heating element having a small cumulative time measured by the time measurement unit.

10. The inkjet recording apparatus according to claim 1, wherein the plurality of heating elements are halogen heaters that operate to generate heat by emitting infrared radiation.

11. The inkjet recording apparatus according to claim 1, further comprising:
a plurality of second heating elements disposed on an inner peripheral side of the second belt along the sheet conveyance direction and that operate to heat the second belt;
a second power supply that operates to supply power to the plurality of second heating elements; and
a second temperature detection unit that operates to detect a temperature of the second belt,
wherein the plurality of heating elements serves as first heating elements,
wherein the power supply serves as a first power supply circuit,
wherein the temperature detection unit serves as a first temperature detection unit,
wherein, to adjust the temperature of the second belt detected by the second temperature detection unit to be the target temperature, the control unit further operates to generate, for the plurality of second heating elements, a plurality of second PWM signals for controlling the second power supply by pulse width modulation, and to individually control the power supplied from the second power supply to the plurality of second heating elements by the plurality of generated second PWM signals, and
wherein, in a case where a temperature difference between the temperature of the second belt and the target temperature is more than or equal to a threshold, the control unit further operates to cause two or more of the plurality of the second heating elements to generate heat by the plurality of second PWM signals, and in a case where the temperature difference between the temperature of the second belt and the target temperature is less than the threshold, the control unit further operates to cause the second heating elements of which number is less than the number of second heating elements in the case where the temperature difference between the temperature and the target temperature of the second belt is more than or equal to the threshold, to generate heat.

12. The inkjet recording apparatus according to claim 11, wherein the control unit generates the plurality of second PWM signals having different duty ratios based on at least the temperature difference between the temperature of the second belt and the target temperature.
